(19) United States
(12) Patent Application Publication
(10) Pub. No.: US 2005/0272854 A1
(43) Pub. Date: Dec. 8, 2005

(54) Reflective plaster finish coating compositions, method for making reflective finish and wall, ceiling or surface formed thereby

(76) Inventors: Daniel Nass, Fox River Grove, IL (US); Warren Nass, Fox River Grove, IL (US)

Correspondence Address: Orum & Roth, 53 West Jackson Blvd., Chicago, IL, 60604, US

(21) Appl. No.: 11/108,330

(22) Filed: Apr. 18, 2005

Related U.S. Application Data
(60) Provisional application No. 60/563,195, filed on Apr. 16, 2004.
(60) Provisional application No. 60/603,729, filed on Aug. 23, 2004.

(51) Int. Cl. C08K 3/40

(52) U.S. Cl. 524/494; 427/162; 427/402

(57) ABSTRACT

A coating composition giving a reflective appearance. A substrate surface is coated with the base coating and allowed to dry. The substrate may be cement, plaster, wood, drywall, metal or other material. A reflective finish coat is applied on top of the base coat and allowed to dry. The reflective appearance is created with the glass spheres carried in the clear finish coat. The glass beads are preferably from about 0.43 mm to about 5 mm in diameter.

This application claims the benefit of U.S. Provisional Application No. 60/563195 filed 16 Apr. 2004 entitled Reflective Plaster Finish Coating Compositions, Method For Making Reflective Finish And Wall, Ceiling Or Surface Formed Thereby and U.S. Provisional Application No. 60/603729 filed 23 Aug. 2004 entitled Reflective Plaster Finish Coating Compositions, Method For Making Reflective Finish And Wall, Ceiling Or Surface Formed Thereby.

### BACKGROUND OF THE INVENTION

1. Field of the Invention

The present invention relates to a plaster wall surface having a reflective. More specifically, the present invention is directed to a two-coating composition, a method for applying the material to a wall to obtain a reflective finish and the reflective wall surface created thereby.

2. Description of the Related Art

Various decorative wall finishes exist. For example, various techniques exist for creating a wall finish that has random swirls or designs, e.g. marble-like, with varying color density, i.e., with lighter portions and darker portions of the same basic color. Wall finishes help define the atmosphere and/or character of a room. Texture, tone, depth, color and luster, and other characteristics are utilized to create and define a room style.

As will be described in greater detail hereinafter, the present invention provides a coating composition including a number of elements, a base or primer layer and a reflective/plaster layer, a method for applying the layers to a wall, a surface, or a ceiling to obtain a decorative reflective surface, and a reflective wall, surface, or ceiling formed thereby.

### SUMMARY OF THE INVENTION

According to the present invention there is provided a base coating composition and a reflective finish coating each comprising a binder or blend of binders, water, particulate materials, and chemical agents. A substrate surface is coated with the base coating and allowed to dry. The substrate may be cement, plaster, wood, drywall, metal or other material. A reflective finish coat is applied on top of the base coat and allowed to dry. The reflective appearance is created with the glass spheres carried in the clear finish coat. The glass beads are preferably from about 0.43 mm to about 5 mm in diameter.

### BRIEF DESCRIPTION OF THE DRAWINGS

FIG. 1 is a cross-section of a reflective surface of the present invention.

FIG. 2 is a front view of a reflective surface of the present invention.

### DESCRIPTION OF THE PREFERRED EMBODIMENT(S)

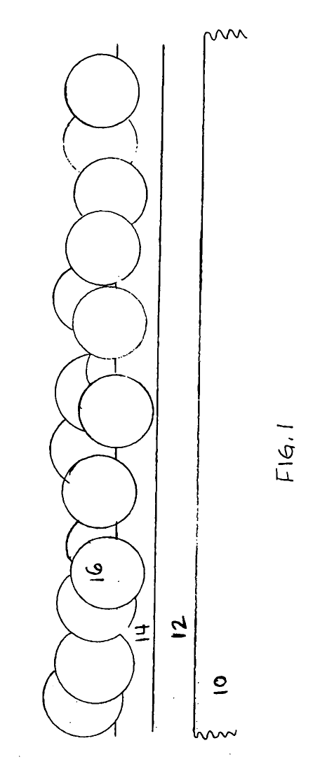

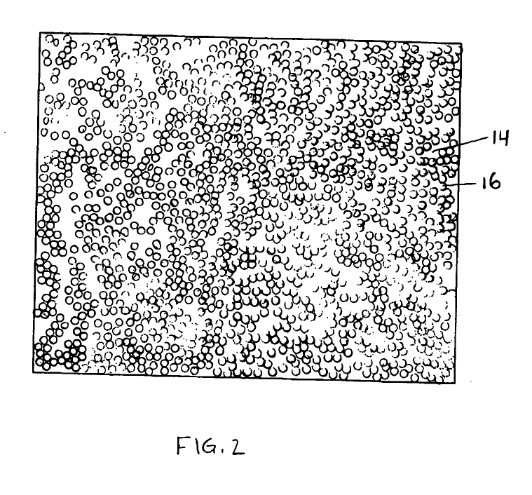

Referring now to FIGS. 1 and 2, there is depicted a magnified cross section of the inventive coatings applied to a surface and a front view of the inventive coatings applied to a substrate surface 10. The base or primer coat 12 provides a strong base over the substrate 10. The substrate 10 may be cement, plaster, wood, drywall, metal or other material. A reflective finish coat 14 is applied on top of the base coat 12.

The base coat 12 composition is prepared. The base coat 12 may be immediately applied to a substrate or the prepared base coat 12 may be stored until needed prior to application on the substrate 10. Base coat 12 is troweled into a smooth even surface across the substrate 10. The base coat 12 is then allowed to dry. The finish coat 14 composition is prepared. The finish coat 14 may be immediately applied to a substrate 10 or the prepared finish coat 14 may be stored until needed. The finish coat 14 is troweled evenly over the dried base coat 12 and allowed to dry. The reflective appearance is created with the glass spheres 16 carried in the clear finish coat 14. The glass beads 16 are preferably from about 0.43 mm to about 5 mm in diameter.

When prepared, base coat 12 and finish coat 14 compositions of the present invention have a consistency that can be spread by trowel (not shown) on a wall, a surface, or a ceiling to be coated to leave on it a thin layer of coating. In addition to its protection of the substrate 10 against environmental influences, the coatings 12, 14 impart to the wall, surface, or ceiling a reflective appearance.

The coatings 12, 14 are made of binding polymers and include fillers and/or extenders. The emulsion binding polymers of choice are acrylic and/or latex polymers. The filler in the base coat 12 composition is preferably marble dust such as the type that can be purchased from RJ Marshall. Alternatively, the filler in the base coat can be calcium carbonate. The filler in the finish coat 14 is glass spheres, preferably about 0.43 mm to about 5 mm in diameter. The coating compositions 12, 14 of the present invention also include thickening agents. A preferred thickener is the type, which can be purchased from Dow Chemical Co. under the brand name TR 115. The coating compositions 12, 14 of the present invention also include solvents such as propylene glycol to reduce the drying time for the coating. The coating compositions 12, 14 of the present invention may also optionally include a number of additional ingredients such as defoamer, pH adjuster, biocide, and mildewcide. Among compounds that are capable of increasing the shelf-life of the prepared coatings 12, 14 by preventing degradation due to bacterial or fungal action are water-based nonmetallic preservatives 5-hydroxymethoxymethyl-1-aza-3,7 dioxybicyclo(3.3.0) octane, and tetrachloroisophthaTonirile. These preservatives are commercially available from ISP Technologies under the trade names of NUOSEPT-95 and NUOCIDE 404D, respectively. The first compound is a bactericide, while the second compound is a fungicide/mildewcide.

The coating compositions 12, 14 may also include pigment, dye, tint or colorant. Preferably, the base coating 12 is colored and the finish coat 14 is clear. The glass spheres 16 may be clear or colored, depending on the desired effect.

The ingredients for each coating are preferably blended until thoroughly mixed, about 20 min. The coating 12, 14 mixtures are immediately ready to apply to substrate 10. Alternatively, the coating mixtures 12, 14 can be stored until needed.

A first base or “primer” coat 12 of the batch of the plaster composition is troweled evenly and smoothly on a flat surface and allowed to set and dry for about 24 hours. This base coat 12 utilizes marble dust, fine silica sand or calcium carbonate as a filler (see Tables 1A and 1B). Then a second or “finish” coat 14 is applied with a trowel (not shown) on top of the dried base coat. The finish coat 14 is allowed to dry. The finish coat uses glass beads 16 as filler. The resulting plaster wall finish is shown in FIGS. 1 and 2.

### EXAMPLES

Tables 1A-1D set forth examples of preferred base coat 12 compositions. Preferably, base coat 12 compositions, set forth in Tables 1A and 1B below, are used in conjunction with the reflective finish coat 14 composition, set forth in Tables 2A-2B. As previously noted the base coat 12 utilizes fine silica sand or marble dust as a filler. Alternatively, calcium carbonate could be used as the filler. The reflective finish coat 14 can also be used with fresco finishes and/or base coats of the type utilized in a fresco finish. U.S. Pat. No. 5,741,844 entitled Coating Composition, Plaster Material, Method for Making Fresco-Like Plaster Wall Finish and Plaster Wall, Ceiling, or Surface Formed Thereby is hereby incorporated by reference in its entirety.

TABLE 1A
PRIMER/BASE COAT

| Ingredient | Function | Manufacturer | % |
|---|---|---|---|
| NEO CAR ACRYLIC | Acrylic Binder | Union Carbide Co. | 10.2-19 |
| 820 | | | |
| UCAR 461 | Latex Binder | Dow Chemical Co. | 4.9-9.1 |
| Water | | | 7.8-13.7 |
| DMAMP 80 | pH Inhibiter | Chachet Chemical | .61-1.13 |
| | | Co. | |
| Defoamer | Defoamer | Dow Chemical Co. | .37-.7 |
| NUCEPT 95 | Mildewcide | ISP Technologies | .37-.7 |
| NUOCIDE 404D | Biocide | ISP Technologies | 1.22-2.28 |
| Propylene Glycol | Solvent | Enco Chemical Co. | .3-.56 |
| Marble Dust | Filler/Extender | RJ Marshall | 44.3-82.3 |
| TR 115 | Thickener | Dow Chemical Co. | .37-.7 |

TABLE 1B
PREFFERED PRIMER/BASE COAT

| | | | | Amount | |
|---|---|---|---|---|---|
| Ingredient | Function | Manufacturer | % | (oz) | |
| NEO CAR | Acrylic Binder | Union Carbide Co. | 14.6 | 32 | |
| ACRYLIC 820 | | | | | |
| UCAR 461 | Latex Binder | Dow Chemical Co. | 7.03 | 16 | |
| Water | | | 10.54 | 14 | |
| DMAMP 80 | pH Inhibiter | Chachet Chemical | .87 | 2 | |
| | | Co. | | | |
| Defoamer | Defoamer | Dow Chemical Co. | .54 | 1.5 | |
| NUCEPT 95 | Mildewcide | ISP Technologies | .54 | 1.5 | |
| NUOCIDE | Biocide | ISP Technologies | 1.75 | 4 | |
| 404D | | | | | |
| Propylene | Solvent | Enco Chemical Co. | .43 | 1 | |
| Glycol | | | | | |
| Marble Dust | Filler/Extender | RJ Marshall | 63.3 | 144 | |
| TR 115 | Thickener | Dow Chemical Co. | .54 | 1.5 | |
| | | | | 227.5 | oz |

TABLE 1C
ALTERNATIVE PRIMER/BASE COAT

| Ingredient | Function | Manufacturer | Wt-% Partial |
|---|---|---|---|
| NATROSOL | Thickener | Aqualon Co. | 3.47-6.45 |
| 250 MHR | | | |
| Propylene Glycol | Solvent | Aldrich Chem. Co. | .88-1.64 |
| Methyl Carbitol | Solvent | Aldrich Chem. Co. | 7.5-10.70 |
| SILWET L-77 | Surfactant | Union Carbide Co. | .042-.078 |
| SNOW-BRIGHT | Extender | Whittaker, Clark & | 7.2-13.91 |
| CLAY | | Daniels | |
| Water | | | 22.2-41.2 |
| Fine Silica Sand | Filler | Wedron Silica Co. | 12.4-23.1 |
| RHOPLEX AC-261 | Acrylic Binder | Rohm & Haas | 3.76-7 |
| RHOPLEX | Acrylic Binder | Rohm & Haas | 10.6-19.7 |
| MULTILOBE 200 | | | |
| TEXANOL | Coalescent | Eastman Chem. Co. | .86-1.61 |
| ANTIFOAM-1410 | Defoamer | Dow Chemical Co. | .12-.24 |
| NUOCIDE 404D | Biocide | ISP Technologies | .84-1.56 |
| NUOSEPT-95 | Mildewcide | ISP Technologies | .07-.13 |

TABLE 1D
PREFERRED ALTERNATIVE PRIMER/BASE COAT

| | | | | Amount | |
|---|---|---|---|---|---|
| | | | Wt-% | 50 lb | |
| Ingredient | Function | Manufacturer | Partial | Batch | |
| NATROSOL | Thickener | Aqualon Co. | 4.96 | 2.48 | |
| 250 MHR | | | | | |
| Propylene | Solvent | Aldrich Chem. Co. | 1.26 | 0.63 | |
| Glycol | | | | | |
| Methyl | Solvent | Aldrich Chem. Co. | 10.70 | 5.35 | |
| Carbitol | | | | | |
| SILWET L-77 | Surfactant | Union Carbide Co. | 0.06 | 0.03 | |
| SNOW- | Extender | Whittaker, Clark & | 10.30 | 5.15 | |
| BRIGHT | | Daniels | | | |
| CLAY | | | | | |
| Water | | | 31.72 | 15.86 | |
| Fine Silica | Filler | Wedron Silica Co. | 17.76 | 8.88 | |
| Sand | | | | | |
| RHOPLEX | Acrylic | Rohm & Haas | 5.38 | 2.69 | |
| AC-261 | Binder | | | | |
| RHOPLEX | Acrylic | Rohm & Haas | 15.14 | 7.57 | |
| MULTILOBE | Binder | | | | |
| 200 | | | | | |
| TEXANOL | Coalescent | Eastman Chem. Co. | 1.24 | 0.62 | |
| ANTIFOAM- | Defoamer | Dow Chemical Co. | 0.18 | 0.09 | |
| 1410 | | | | | |
| NUOCIDE | Biocide | ISP Technologies | 1.20 | 0.60 | |
| 404D | | | | | |
| NUOSEPT-95 | Mildewcide | ISP Technologies | 0.10 | 0.05 | |
| | | | | 50.00 | lb |

The base coat 12 is prepared by mixing the ingredients until thoroughly mixed, about 20 minutes. Preferably, the base coat contains a colorant. Once the base coat 12 composition is prepared, it may be immediately applied to a substrate or the prepared base coat 12 may be stored until needed. Base coat 12 is troweled into a thin, smooth, even surface across the substrate 10. The base coat 12 is allowed to dry before the finish coat is applied.

TABLE 2B
PLASTER/REFLECTIVE FINISH COAT

| | | | Amount |
|---|---|---|---|
| Ingredient | Function | Manufacturer | (oz) |
| NEO CAR | Acrylic Binder | Union Carbide Co. | 22.4-41.6 |
| ACRYLIC 820 | | | |
| UCAR 461 | Latex Binder | Dow Chemical Co. | 11.2-20.8 |
| Water | | | 16.8-31.2 |
| DMAMP 80 | pH Inhibiter | Chachet Chemical Co. | 1.4-2.8 |
| Defoamer | Defoamer | Dow Chemical Co. | 1.05-1.95 |
| NUCEPT 95 | Mildewcide | ISP Technologies | 1.05-1.95 |
| NUOCIDE 404D | Biocide | ISP Technologies | 2.8-5.2 |
| Propylene Glycol | Solvent | Enco Chemical Co. | .7-1.3 |
| Solid Glass Spheres | Filler | RJ Marshall | 2.8-5.2 |
| TR 115 | Thickener | Dow Chemical Co. | 1.05-1.95 |

TABLE 2B
PREFERRED PLASTER/REFLECTIVE FINISH COAT

| | | | Amount |
|---|---|---|---|
| Ingredient | Function | Manufacturer | (oz) |
| NEO CAR ACRYLIC | Acrylic Binder | Union Carbide Co. | 32 |
| 820 | | | |
| UCAR 461 | Latex Binder | Dow Chemical Co. | 16 |
| Water | | | 24 |
| DMAMP 80 | pH Inhibiter | Chachet Chemical | 2 |
| | | Co. | |
| Defoamer | Defoamer | Dow Chemical Co. | 1.5 |
| NUCEPT 95 | Mildewcide | ISP Technologies | 1.5 |
| NUOCIDE 404D | Biocide | ISP Technologies | 4 |
| Propylene Glycol | Solvent | Enco Chemical Co. | 1 |
| Solid Glass Spheres | Filler | RJ Marshall | 4 |
| TR 115 | Thickener | Dow Chemical Co. | 1.5 |

The finish coat 14 is prepared by mixing the ingredients until thoroughly mixed, about 20 minutes. Preferably, the finish coat 14 is clear. The glass beads 16 are preferably solid glass spheres. The glass beads 16 may be colored or clear as required for the desired effect. The glass beads 16 are preferably from about 0.43 mm to about 5 mm in diameter. The glass beads are preferably made from recycled glass. Once the finish coat 14 composition is prepared, it may be immediately applied over the dried base coat 12 or the prepared finish coat 14 may be stored until needed. Finish coat 12 is troweled into a thin, smooth, even surface over the dried base coat 12. The finish coat 14 is allowed to dry.

From the foregoing description, it will be apparent that the plaster wall surface, the ingredients from which it is made and the manner and method by which it is created have a number of advantages. Furthermore, modifications can be made to the composition of the plaster wall, ceiling, or other surface and the mixture of materials and ingredients used to make the coatings without departing from the teachings of the present invention.

1. A reflective plaster finish coating composition comprising a base coat and a finish coat, said finish coat comprising:
25.6-47.5% by weight of a first acrylic binder;
12.8-23.8% by weight of a first latex binder;
19.2-35.7% by weight water;
0.8-1.5% by weight of a first solvent;
3.2-6% by weight of a first filler; and
1.2-2.25% by weight of a first thickener;
wherein the first filler comprises glass beads.

2. The reflective plaster finish coating composition of claim 1 wherein the base coat comprises:
said base coat comprising:
10.2-19% by weight of a second acrylic binder;
4.9-9.1% by weight of a second latex binder;
7.8-13.7% by weight of water;
0.3-0.56% by weight of a second solvent
44.3-82.3% by weight of a second filler; and
0.37-0.7% by weight of a second thickener.

3. The reflective plaster finish coating composition of claim 2 wherein the finish coat further comprisies:
1.6-3% by weight of a first pH inhibitor;
1.2-2.25% by weight of a first mildewcide;
1.2-2.25% by weight of a first defoamer; and
3.2-6% by weight of a first biocide

4. The reflective plaster finish coating composition of claim 2 wherein the base coat further comprises:
0.61-1.13% by weight of a second pH inhibitor
0.37-0.7% by weight of a second defoamer;
0.37-0.7% by weight of a second mildewcide; and
1.22-2.28% by weight of a second biocide.

5. The reflective plaster finish coating composition of claim 1 wherein the finish coat consists essentially of:

| Ingredient | Weight % |
|---|---|
| Acrylic Binder | 22.4-41.6 |
| Latex Binder | 11.2-20.8 |
| Water | 16.8-31.2 |
| pH Inhibiter | 1.4-2.8 |
| Defoamer | 1.05-1.95 |
| Mildewcide | 1.05-1.95 |
| Biocide | 2.8-5.2 |
| Solvent | .7-1.3 |
| Filler | 2.8-5.2 |
| Thickener | 1.05-1.95 |

6. The reflective plaster finish coating composition of claim 2 wherein the base coat consists essentially of:

| | Percentage by |
|---|---|
| Ingredient | Weight |
| acrylic binder | 10.2-19% |
| latex binder | 4.9-9.1% |
| Water | 7.8-13.7% |
| pH inhibiter | 0.61-1.13% |
| defoamer | 0.37-0.7% |
| mildewcide | 0.37-0.7% |
| Biocide | 1.22-2.28% |
| Solvent | 0.3-0.56% |
| filler/extender | 44.3-82.3% |
| Thickener | 0.37-0.7% |

7. The reflective plaster finish coating composition of claim 1 wherein the glass beads are glass spheres.

8. The reflective plaster finish coating composition of claim 6 wherein the glass spheres have a diameter of about 0.43 mm—about 5 mm.

9. The reflective plaster finish coating composition of claim 2 wherein the second filler is marble dust, silica sand, or calcium carbonate.

10. The reflective plaster finish coating composition wherein the base coat and/or or the finish coat further comprises a colorant.

11. The reflective plaster finish coating composition of claim 10 wherein the base coat further comprises a colorant.

12. The reflective plaster finish coating composition of claim 1 wherein the glass beads are colored.

13. The reflective plaster finish coating composition of claim 1 wherein the base coat comprises:
3.47-6.45% by weight of a second thickener;
0.88-1.64% by weight of a second solvent;
7.5-10.70% by weight of a third solvent;
0.042-0.078% by weight of a second surfactant;
7.2-13.91% by weight of a second extender;
22.2-41.2% by weight water;
12.4-23.1% by weight of a second filler;
3.76-7% by weight of a second acrylic binder;
10.6-19.7% by weight of a third acrylic binder;
0.86-1.61% by weight of a coalescent;
0.12-0.24% by weight of a second defoamer;
0.84-1.56% by weight of a second biocide; and
0.07-0.13% by weight of a second mildewcide

14. The reflective plaster finish coating composition of claim 1 wherein said base coat consists essentially of:

| Ingredient | Weight % |
|---|---|
| Thickener | 3.47-6.45% |
| Solvent | 0.88-1.64% |
| Solvent | 7.5-10.70% |
| Surfactant | 0.042-.078% |
| Extender | 7.2-13.91% |
| Water | 22.2-41.2% |
| Filler | 12.4-23.1% |
| Acrylic Binder | 3.76-7% |
| Acrylic Binder | 10.6-19.7% |
| Coalescent | 0.86-1.61% |
| Defoamer | 0.12-0.24% |
| Biocide | 0.84-1.56% |
| Mildewcide | 0.07-0.13% |

15. The reflective plaster finish coating composition of claim 12 wherein the finish coat further comprisies:
1.6-3% by weight of a first pH inhibitor;
1.2-2.25% by weight of a first mildewcide;
1.2-2.25% by weight of a first defoamer; and
3.2-6% by weight of a first biocide

16. The reflective plaster finish coating composition of claim 1 wherein the base coat is a fresco finish coating or a fresco finish base coat.

17. A method of making a reflective finish surface comprising the steps of:
troweling a base coat into a thin, smooth even surface on a substrate;
drying the base coat;
applying a finish coat over the dried base coated surface;
drying the finish coat; and
wherein the finish coat comprises glass beads.

18. The method of claim 16 further comprising the step of preparing the finish coat, wherein preparing said finish coat comprises the following step:
mixing 25.6-47.5% by weight of a first acrylic binder; 12.8-23.8% by weight of a first latex binder; 19.2-35.7% by weight water; 0.8-1.5% by weight of a first solvent; 1.6-3% by weight of a first pH inhibitor; 1.2-2.25% by weight of a first mildewcide; 1.2-2.25% by weight of a first defoamer; and 3.2-6% by weight of a first biocide; 3.2-6% by weight of the glass beads; and 1.2-2.25% by weight of a first thickener until thoroughly mixed.

19. The method of claim 17 further comprising the step of preparing the base coat, wherein preparing said base coat comprises the following step:
mixing 10.2-19% by weight of a second acrylic binder; 4.9-9.1% by weight of a second latex binder; 7.8-13.7% by weight of water; 0.3-0.56% by weight of a second solvent; 44.3-82.3% by weight of a second filler; 0.61-1.13% by weight of a second pH inhibitor; 0.37-0.7% by weight of a second defoamer; 0.37-0.7% by weight of a second mildewcide; and 1.22-2.28% by weight of a second biocide; and 0.37-0.7% by weight of a second thickener until thoroughly mixed.

20. The method of claim 19 wherein the base coat further comprises a colorant.

21. The method of claim 20 wherein the glass beads are glass spheres having a diameter of about 0.43 mm to about 5 mm.
